(19) United States
(12) Patent Application Publication
(10) Pub. No.: US 2026/0201149 A1
(43) Pub. Date: Jul. 16, 2026

(54) AQUEOUS DISPERSIONS FOR PRODUCING FLAME-RETARDANT FOAMED FILMS AND FOR PRODUCING COMPOSITE STRUCTURES EQUIPPED THEREWITH

(71) Applicant: BENECKE-KALIKO AKTIENGESELLSCHAFT, Hannover (DE)

(72) Inventors: Andreas Gerken, Hannover (DE); Mathias Rohn, Hannover (DE); Christoph Sonnenschein-Battefeld, Hannover (DE)

(73) Assignee: Benecke-Kaliko AG, Hannover (DE)

(21) Appl. No.: 18/859,803

(22) PCT Filed: Apr. 4, 2023
(86) PCT No.: PCT/DE2023/200072

§ 371 Date: Oct. 24, 2024

(30) Foreign Application Priority Data
Apr. 29, 2022 (DE) 10 2022 204 206.9

(51) Int. Cl. C08K 5/3492; C08G 71/04; C08K 5/5313; D06N 3/00; D06N 3/14

(52) U.S. Cl. CPC C08K 5/34924; C08G 71/04; C08K 5/5313; D06N 3/0043; D06N 3/0059; D06N 3/009; D06N 3/14; D06N 2201/02; D06N 2209/067

(57) ABSTRACT

An aqueous polymer dispersion including a dispersed polymer, a foam stabilizer and a flame retardant mixture containing melamine cyanurate and an aluminum phosphinate. The combination of flame retardants makes it possible to form homogeneous foams formed with air which may be used to produce thick solidified foam layers for imparting a pleasant haptic impression without any need to include halogen-containing flame retardants. The solidified foams thus produced also feature improved thickness stability upon exposure to elevated temperatures. Also provided are laminate structures including two or more layers, at least one layer of which is obtainable by solidifying the aqueous polymer dispersion, and to the use of a flame retardant combination containing melamine cyanurate and an aluminum phosphinate for reducing the thickness shrinkage of a solidified foam layer formed from the polymer dispersion according to the invention.

The present invention relates to aqueous polymer dispersions comprising a dispersed polymer, a foam stabilizer and a flame retardant mixture containing melamine cyanurate and an aluminum phosphinate. The present invention further relates to laminate structures comprising two or more layers, at least one layer of which is obtainable by solidifying an aqueous polymer dispersion according to the invention, and to the use of a flame retardant combination containing melamine cyanurate and an aluminum phosphinate for reducing the thickness shrinkage of a solidified foam layer formed from the polymer dispersion according to the invention.

### PRIOR ART

Surface materials comprising at least one polyurethane layer are often used as a leather substitute/as a material for upholstery of furniture and automotive components or else for the production of bags, shoes, etc. These surface materials generally have a decorative surface structure or grain which is configured as a geometric structure or with a leather-like look. In this case, the surface materials are configured as artificial leather, i.e. they look like leather but are not based on animal skin.

Such polyurethane artificial leathers are often used on account of their pleasant haptics and are usually difficult to distinguish from leather on their visible side. Since the quality of leather varies from skin to skin, the availability of leather of sufficient quality for decorative purposes is limited, the price of leather is comparatively high and consumers are increasingly demanding “animal-free” (vegan) products, recent years have seen increasing demand and use of artificial leather as a substitute for leather.

Polyurethane-based artificial leathers are often produced using solvents and solvent-based raw materials. The production of coagulated polyurethane artificial leathers using toxic N,N-dimethylformamide is still widespread. Other solvents also remain in frequent use but especially for automotive applications must only be detectable in the end product in trace amounts. The use of these solvents is also regarded in a critical light for the workers involved in the production process and for the environment.

So-called high-solid polyurethane systems are known as a means for reducing solvent emissions but generally contain a blocking agent to reduce the reactivity of the employed isocyanates in order to control the production reaction. At least a proportion of these blocking agents (e.g. 2-butanone oxime) often remain in the end product, thus leading to an unpleasant odor and an elevated VOC (volatile organic compound) value. These blocking agents are also considered as toxicologically concerning in many countries.

Due to the markedly lower cost compared to leather and polyurethane artificial leathers, large amounts of PVC-based artificial leathers are also used. However, these must be produced with a relevant content of plasticizers which have been the subject of public debate for years and whose use is increasingly seen in a critical light.

The use of plasticizers has been increasingly restricted in recent years, for example by REACH regulations, the GADSL list from automakers and the like. In addition, plasticizers are not securely bound in the PVC matrix and they therefore migrate out of the polymer matrix over time, thus altering the flexibility properties of a PVC artificial leather. A further problem occurs upon prolonged exposure to high temperatures which can occur in automotive dashboard applications; such exposure can lead to discoloration and a reduction in mechanical stability since hydrochloric acid is released from the PVC and the PVC polymer chains are destroyed.

It has been established in the prior art that to produce pleasant touch haptics and to avoid a structure of an employed carrier textile from showing or pressing through, a foamed layer is employed in such artificial leathers or laminate structures in a non-surface-visible ply having a relatively high thickness compared to the other layers.

Recently, aqueous polyurethane and/or polyacrylate dispersions are increasingly being used to produce artificial leathers. These are generally low-solvent or solvent-free. However, the production of relatively thick dry films poses considerable difficulties. If these layers are compact, it is generally not possible to achieve economically fast drying of thick layers at elevated temperatures without bubble formation due to evaporating water or other defects.

This disadvantage may be overcome by admixing aqueous dispersions with foaming auxiliaries (surfactants) and mechanically foaming such layers by beating. Obtained as products in this case are open-celled foam layers which are capable of fast drying due to the large surface area of the film. Such foams are described for example in EP 0235949 A1, EP-0246723 A2 or DE 10 2007 048 079 A1. However, the disadvantage of such a procedure is that such foams have low wall thicknesses and limited mechanical stabilities of the foam micelles, thus resulting in an irreversible reduction in thickness, especially under mechanical or thermal stress, as occurs for example upon winding a foamed film onto a roll or upon exposure to heat and sunlight in the installed state (for example on an automotive dashboard).

A further disadvantage of these solutions is that these foams cannot readily be employed for preparing artificial leathers or similar laminate structures since they must be provided with additional flame retardants due to regulatory requirements relating to the flame retardancy of such materials. Such flame retardants may only be added in a limited amount in order not to hinder foaming behavior during production and the formation of agglomerates of the flame retardant during incorporation must also be avoided. In addition, the flame retardant must also not significantly alter the final properties of the artificial leather under stress, for example must not lead to severe shrinkage or marked visible discoloration of the artificial leather upon prolonged high-temperature storage at 100° C.

Furthermore, the flame retardant must also not alter the pH to such an extent that the foam auxiliaries become ineffective and production of a homogeneous foam is no longer possible. An excessive increase in viscosity as a result of addition of the flame retardant, which can render homogeneous foaming impossible, must also be avoided. In addition, the use of halogenated flame retardants must also be avoided since these are concerning in terms of toxicology and environmental contamination.

EP 3 623 490 A1 describes flame-retardant dispersions used as beaten foam. The dispersions employed here contain integrated flame retardant constituents such as for example phosphorus-containing polyols with the result that additional flame retardants are not necessary for a flame retardant effect. However, the disadvantage of this solution is that such dispersions generally have a relatively low solids content of 30-35% which makes foaming and efficient drying of such foams difficult and that such dispersions generally contain co-solvents such as N-butyl-2-azacyclopentanone or neutralizing agents such as amines which can escape from the material as emissions after processing.

The production of polyurethane foams from mixtures of isocyanates or isocyanate prepolymers with polyols and/or polyamines and water is also known (see for example U.S. Pat. Nos. 3,978,266, 3,975,587 or EP 0059048 A1). However, such reactive mixtures often do not produce a homogeneous foam structure as is necessary for high-quality artificial leather and handling in the production process for artificial leather is very complex due to short reaction times/pot lives.

Foamed polyurethane layers for use in artificial leathers may further be produced through the use of chemical blowing agents which are added to a polyurethane composition and decompose upon heating to release gas. However, foams produced in this way show a very inhomogeneous foam structure and are not employable in aqueous dispersions since the decomposition point of the customary chemical blowing agents is above the boiling temperature of water, so that simultaneous homogeneous drying and foaming is impossible.

Foamed polyurethane layers may further be produced by adding hollow microspheres filled with blowing gas (for example isobutane, isopentane) to a polyurethane composition. The composition may then be dried as a film by heating, with the result that the blowing gas in the hollow microspheres expands and the diameter of the hollow microspheres increases, thus forming a foam. However, homogeneous and uniformly foamed polyurethane films are only producible if little or no solvent or water is present in the composition. If relatively large amounts of water or solvents are also present, the expanding hollow microspheres are impeded. Especially with thicker layers, such as are desirable for producing haptically pleasant artificial leather, the evaporation of water or solvents during relatively fast drying also leads to defects such as bubbles, holes or cracks in the manufactured film.

It is alternatively also possible to employ pre-expanded hollow microspheres or glass hollow microspheres. However, these float during production of the composition on account of their low density, thus preventing formation of a homogeneous mixture. Furthermore, a larger usage amount as necessary for producing a homogeneous foam in turn impedes the evaporation of water or solvent, as associated with the above-described adverse consequences.

WO 2019/174754 describes a process for producing a layered structure where a foamed polyurethane beaten foam may contain hollow microspheres. However, the advantage according to that invention arises only from the use of the polyurethane beaten foam which describes production of preferably surface-structured layer structures which is improved from a process engineering standpoint. According to that invention, the beaten foam must be produced with defined stirring (“such as for production of whipped cream or meringue”). The addition of gas-filled hollow spheres is only optional and according to WO 2019/174754 the employed gas-filled hollow spheres are not intended for a subsequent further expansion. Thus, example 2 of WO 2019/174754 employs hollow microspheres having a diameter of 20 μm and the corresponding mixture is dried at 115° C. and for a short time at 120° C. Customary expandable hollow microspheres having such a diameter (from Sekisui or Nouryon) show only minimal expansion behavior, if any, at these temperatures. Furthermore, the formulations for beaten foams described in WO 2019/174754 contain no flame retardant additives.

DE 10 2019 218 950 A1 also describes the use of expandable hollow microspheres to produce a layer having a foam structure for a laminate structure in a mechanically foamed dispersion.

When using such expandable or already pre-expanded hollow microspheres, it is generally disadvantageous that in emission testing (for example in VDA 277) on the products the short-chain hydrocarbons such as butane, isobutane, pentane or isopentane utilized for the expansion are always detectable in significant amounts.

Against this backdrop, there is a need for compositions which can be beaten into foams using air and which make it possible to produce relatively thick solidified foam layers having the most homogeneous distribution possible of bubbles in the foam, wherein the foams are flame-retarded such that a desired high flame retardancy can be ensured at a relatively low content of (halogen-free) flame retardant. Ideally, this solution shall be achievable with little use of volatile solvents and hydrocarbons in order to ensure that high emission standards, for example for automotive interiors, can be met.

The present invention addresses this need.

### DESCRIPTION OF THE INVENTION

In the studies underlying the present application, it has surprisingly been found that the properties required for thick solidified foams are achievable with a mixture of flame retardants containing melamine cyanurate and aluminum phosphinate. The combination of flame retardants also makes it possible to achieve a surprisingly advantageous shrinkage behavior upon exposure of the foams to elevated temperatures which is a desirable property especially for applications in automotive interiors.

In a first aspect, the present invention accordingly relates to an aqueous polymer dispersion containing a dispersed polymer, a foam stabilizer and a flame retardant mixture comprising melamine cyanurate and an aluminum phosphinate.

The dispersed polymer, which forms the main component of the aqueous polymer dispersion, is not subject to any relevant restrictions provided the polymer is suitable for production of solidified polymer foams. In a preferred embodiment, the polymer is a polyurethane or acrylate polymer.

Polyurethanes describe polymers which are generally formed from polyisocyanates and polyols and comprise urethane groups (—NH—CO—O—) between the units forming the polymer. In the invention described here, polyurethanes may additionally also contain urea groups (—NH—CO—NH—) which may result from hydrolysis of isocyanate groups and subsequent reaction of the amines formed with isocyanates. In addition, the urethane may contain further functional groups, such as in particular ether, ester or carbonate groups, which are present in the form of polyether polyols or polyester polyols in a polyol precursor of the polyurethanes and thiourethane groups which may result from a reaction of thiols with isocyanates. The polyurethane is generally formed from polyurethane precursors, wherein these are polyisocyanates and polyols, but also isocyanate prepolymers obtained by reaction of polyols with an excess of polyisocyanate. Such isocyanate prepolymers are often formed with an excess of isocyanate groups (NCO) to OH groups of 2:1 or more, so that these isocyanate prepolymers are on average formed from one polyol unit and two polyisocyanate units; at higher NCO/OH ratios, free polyisocyanate is additionally present.

According to the invention, the polyurethane is formulated as a dispersion in which at least a proportion of the polyurethane is present distinctly as a separate phase to the solvent. The solvent is preferably water.

From a process engineering standpoint, it is moreover preferable when the polyurethane in the polymer dispersion has a low level of branching. The polyurethane is preferably linear, i.e. the polyols and polyisocyanates from which the polyurethane or the polyurethane precursors are formed are each difunctional (in respect of OH and NCO). As mentioned, a small proportion of tri- or polyfunctional polyols and polyisocyanates (e.g. up to 5% by weight respectively and preferably up to 2% by weight respectively) can be tolerated without this having an adverse effect on processability to a relevant extent, especially when the proportion of the tri- or polyfunctional polyols and polyisocyanates is compensated by higher molecular weights of the polyols (e.g. 1 trifunctionality for a molecular weight of at least 2000 g/mol and preferably at least 3000 g/mol).

Preferred polyisocyanates from which the polyurethane is formed in the flowable formulation according to the invention comprise aliphatic polyisocyanates such as isophorone diisocyanate, hexamethylene diisocyanate, dicyclohexylmethane 4,4′-diisocyanate, hexane diisocyanate and bis(isocyanatomethyl)cyclohexane.

Suitable polyols from which the polyurethane may be formed in the flowable formulation according to the invention are bifunctional polyols and in particular bifunctional aliphatic polyols such as polyether glycol (e.g. polyethylene glycol, polypropylene glycol or polytetrahydrofuran diol), polyester glycol (e.g. based on adipic acid and α,ω-aliphatic diols having 1 to 8 and preferably 4 to 6 CH₂ units), polythioether polyol, polycarbonate polyol (e.g. based on 1,6-hexanediol), a hydroxyl-containing aliphatic polyacetate and/or a hydroxy-containing aliphatic polycarbonate. In a preferred embodiment, the polyurethane contains a polyether diol and/or a polyester diol. It is very particularly preferable when the polyurethane contains polyurethane units which may preferably result from polyether polyols or polyesters extended with polyethers. These polyols preferably have a molecular weight Mw of 200 to 12 000, in particular of 500 to 2000, wherein the molecular weight average is determinable by GPC using suitable standards (such as especially polystyrene). It is additionally possible to employ short-chain chain extenders such as especially α,ω-aliphatic diols having 1 to 8 and preferably 4 to 6 CH₂ units, α,ω-aliphatic diamines having 1 to 8 and preferably 4 to 6 CH₂ units or other organic compounds having two or more reactive groups that are employed as chain extenders as OH groups, SH groups, NH groups, NH₂ groups or CH-acidic groups, for example in β-diketo compounds, wherein these should preferably have a molecular weight of less than 500 g/mol and in particular a molecular weight of less than 300 g/mol.

Suitable acrylate polymers for the production of foams include for example the materials described in EP 3 929 231 A1 (e.g. in [0040]) or EP 3 623 400 A1 (e.g. in [0037]). Similarly to the polyurethanes, polyacrylates can also contain one or more functional groups such as ester, ether, carbonate or urea groups.

The polymer in the polymer dispersion according to the invention is preferably a polyurethane polymer.

The proportion of the dispersed polymer in the aqueous polymer dispersion is preferably 30% to 60% by weight and in particular 40% to 60% by weight based on the dry weight of the polymer dispersion. Including the water, this preferably gives a proportion of 55% to 90% by weight and in particular 65% to 80% by weight, then based on the total weight of the polymer dispersion.

The second invention-relevant constituent of the polymer dispersion according to the invention is a foam stabilizer, wherein this is preferably an ionic or nonionic surfactant. Particularly suitable foam stabilizers include surfactants such as ammonium stearate (commercially available for example as Stokal® STA from Bozzetto Group), succinamate (commercially available for example as Stokal® SR) or the sodium salt of fatty acid alkyl polyglycol ether sulfates (commercially available for example as Stokal® SAF new). In a particularly preferred embodiment, the foam stabilizer employed is a mixture of ammonium stearate, succinamate and sodium salt of fatty acid alkyl polyglycol ether sulfates.

Alternatively or in addition, it is also possible to employ further surfactants which may preferably be selected from the group consisting of ether sulfates, fatty alcohol sulfates, sarcosinates, organic amine oxides, sulfonates, betaines, amides of organic acids, sulfosuccinates, sulfonic acids, alkanolamides, ethoxylated fatty alcohols, sorbinates and combinations thereof.

In the investigations performed in the context of the present invention, it has surprisingly been found that many flame retardants can markedly reduce the pH of a dispersion with the result that foam stabilizers used for producing a foam are no longer effective. The use of the flame retardant combination according to the invention avoids such an effect, with the result that anionic surfactants may be readily employed in these polymer dispersions. It is accordingly preferable when the foam stabilizer is at least partially formed by an anionic surfactant (such as a salt of ether sulfates).

The surfactant amount is to be adjusted to a level suitable for generating a foam having suitable properties and a desired gas content. It is preferable when the proportion of the surfactant here is in the range from about 1% to 12% by weight, more preferably about 2% to 10% by weight and yet more preferably about 4% to 8% by weight based on the total weight of the aqueous polymer dispersion.

As the third constituent essential to the invention, the polymer dispersion according to the invention contains a flame retardant mixture containing melamine cyanurate and an aluminum phosphinate. The aluminum phosphinate is preferably employed in the form of aluminum dialkylphosphinate and in particular in the form of aluminum diethylphosphinate. Aluminium diethylphosphinate is available for example as Exolit OP 1230 from Clariant. The flame retardant mixture makes it possible to realize incorporation of the flame retardants into the aqueous polymer dispersion while avoiding agglomerate formation and without a marked increase in viscosity. Compared to the use of only melamine cyanurate or only aluminum phosphinate, a markedly better burn rate is achieved.

The total amount of flame retardant in the aqueous dispersion according to the invention is preferably in the range from 10% to 30% by weight, in particular 12% to 25% by weight, and more preferably 15% to 20% by weight, wherein the amount of flame retardant is based on the total weight of the aqueous dispersion (including water as solvent).

The ratio of melamine cyanurate and aluminum phosphinate is not subject to any relevant restrictions, although advantageously both flame retardants should be present in a relevant proportion (at least 5% by weight based on the total weight of the flame retardants in the aqueous dispersion). It is preferable when melamine cyanurate and aluminum phosphinate are present in a ratio of 10:1 to 1:10, more preferably 5:1 to 1:5 and yet more preferably 3:1 to 1:3; a ratio of about 1:1 to 1:2 is very particularly preferable.

In addition to the two recited flame retardants, the aqueous dispersion according to the invention can contain further flame retardants which comprise but are not limited to organic phosphorus compounds such as organic phosphinate, aryl phosphate ester or phosphorous-containing polyol, ammonium polyphosphate, melamine phosphate, melamine, melamine phosphate or polyphosphate, red phosphorus, aluminum trihydroxide, magnesium hydroxide, zinc stannate, expandable graphite and zinc borate. However, since these flame retardants can impair the advantageous effect of the inventive flame retardant mixture of melamine cyanurate and aluminum phosphinate, it is preferable when such additional flame retardants account for a proportion of less than 30% by weight based on the total amount of flame retardant, in particular less than 20% by weight and more preferably less than 10% by weight. In a very particularly preferred embodiment, the aqueous dispersion according to the invention contains only melamine cyanurate and aluminum phosphinate, in particular in the form of aluminum diethylphosphinate, as flame retardant.

Since, in the event of fire, halogen-containing flame retardants can release hydrogen halides which are toxic, it is also preferable when the aqueous polymer dispersion according to the invention is free from halogen-containing flame retardants.

As mentioned above, the aqueous polymer dispersions according to the invention are especially intended to produce solidified foam films such that in a preferred embodiment the aqueous polymer dispersion is configured as a foam containing bubbles of a gas. It is preferable when this foam has a gas content in the range from 10% to 65% by volume and preferably 25% to 55% by volume which makes it possible to realize an advantageous haptic feel that is associated with the haptics of leather by the consumer. The gas is advantageously air but may also be an inert gas such as nitrogen, argon or carbon dioxide.

In addition to the constituents recited in the foregoing, the aqueous dispersion according to the invention may contain further additives for controlling properties. For example, it may be desirable if the polymer is partially crosslinked as a result of the formation of a polymer layer. To this end, the aqueous dispersion may additionally comprise suitable crosslinkers, for example based on isocyanates, carbodiimides and/or epoxides. A suitable proportion for such crosslinkers may be an amount in the range of up to 5% by weight based on the dry mass of the aqueous dispersion, wherein the proportion is typically in the range from 0.2% to 4% by weight and preferably about 1% to 3% by weight. For aqueous dispersions containing a polyurethane as polymer, it is preferable when a crosslinker based on isocyanates is included in the dispersion.

Customary additives that may be included in the aqueous dispersion and be present therein in addition to crosslinking agents include those selected (without limitation) from fillers, in particular mineral and/or biobased fillers, thickeners, rheology additives, pH regulators, aging stabilizers, solvents and pigments. A suitable thickener is for example a thickener based on acrylate copolymers.

In the case of additives such as thickeners, rheology additives, pH regulators, aging stabilizers and pigments, it is usually sufficient when these are included in the aqueous dispersion according to the invention in relatively small amounts so that the total content thereof generally does not exceed 10% by weight based on the dry content of the aqueous dispersion. For solvents or hydrocarbons, it is preferable when these are not included in the aqueous dispersion according to the invention (i.e. also not included in encapsulated form, for example in hollow microspheres filled with hydrocarbons) since such solvents require subsequent removal from the product produced from the aqueous dispersion.

By contrast, fillers may also be included in the aqueous dispersion according to the invention in relatively large amounts, for example in a proportion of up to 40% by weight and preferably about 10% to about 30% by weight. In one embodiment, the aqueous dispersion according to the invention contains no added fillers.

As mentioned above, it is advantageous in terms of the stability of a produced foam when the aqueous dispersion has a virtually neutral pH. To this end, the aqueous polymer dispersion according to the invention therefore preferably has a pH of 5 to 10 and preferably 6 to 9. To adjust the pH, the aqueous polymer dispersion may contain a neutralizing agent, wherein it is preferable when the neutralizing agent employed comprises amines to a small extent, if any, (maximum content in the composition preferably 0.5% by weight and in particular 0.2% by weight) since these can subsequently escape from the solidified foam as emissions.

In a further aspect, the present invention relates to a laminate structure comprising two or more layers in which at least one of the layers is formed by solidifying an aqueous polymer dispersion according to the above-described first aspect. The layer produced by solidifying the aqueous polymer dispersion is preferably present in the form of a foam layer. The foam layer preferably has a thickness in the range from 100 μm to 2 mm and in particular in the range from 300 μm to 1 mm.

In a particularly preferred embodiment, the laminate structure according to the invention comprises an embossed or grained compact outer layer, a layer of solidified foam and a textile carrier layer on the side of the laminate structure opposite the outer layer, wherein the layer of solidified foam is formed from the aqueous polymer dispersion according to the above-described first aspect. The embossed or grained outer layer comprises a particular and desired three-dimensional surface structure which in the case of an embossing may be uniform and in the case of a grain may be configured such that the user associates the structure with a leather surface; this may have the appearance of a split leather or of the surface of a real leather facing the hair side (or outside if no hair is present).

In the laminate structure according to the invention, the outer layer is advantageously a polyurethane outer layer such as is known from artificial leather applications, for example an aliphatic polyether polyurethane dispersion. The outer layer preferably has a thickness of 15 to 100 μm, more preferably of 25 to 80 μm and yet more preferably of 40 to 75 μm.

The textile carrier layer may be selected from any textiles typically employed in the field of artificial leather, in particular textiles based on polyesters.

In the laminate structure according to the invention, the textile carrier layer is advantageously bonded to the solidified foam layer formed from the polymer dispersion according to the invention using an adhesive or a laminating composition, wherein in a preferred embodiment the foam layer and the laminating composition are based on a polyurethane. In this case, the polyurethane may be made of identical or similar constituents to the polyurethane present in the solidified foam, wherein the laminating composition contains no foam stabilizer and need not contain any flame retardant or mixture of flame retardants. It is preferable to employ an aliphatic polyurethane in the laminating composition. The laminating composition is advantageously configured with a thickness in the range from 50 to 500 μm and preferably 100 to 300 μm in the laminate system according to the invention.

For the laminate structure according to the invention, it is further preferred if it has a lowest possible burn rate, wherein in the context of the present invention the burn rate is determined according to FMVSS 302. The laminate structure according to the invention especially has a burn rate of not more than 80 mm/min, more preferably not more than 50 mm/min and yet more preferably not more than 30 mm/min. To this end, it is also preferable when the solidified foam layer in the laminate structure comprises a proportion (based on the weight of the solid contents of the solidified foam layer) of at most 35% by weight and preferably at most 30% by weight and yet more preferably at most 28% by weight.

Other laminate structures producible by solidifying an aqueous polymer dispersion according to the invention especially include laminate structures that are intended to exhibit soft haptics or breathability. A solidified foam film based on the present invention may in principle be employed in any desired laminate or else as an individual film, for example as an individual film for coating a textile or leather.

Yet a further aspect of the present invention relates to a process for producing a laminate structure as described above, wherein an aqueous polymer dispersion according to the above-described first aspect and preferably in the form of a foam is applied to a substrate and solidified to afford a cohesive layer. The solidifying is generally carried out by drying the foam to evaporate water and thus remove it from the aqueous dispersion to effect solidification. In a preferred embodiment, the process comprises a step i) of applying an outer layer, preferably based on polyurethane, to a substrate which may have a surface structure corresponding to the negative of a leather grain, solidifying the outer layer, applying the aqueous polymer dispersion in foam form to the outer layer and solidifying same, applying an adhesive layer or laminating composition, preferably based on polyurethane, to the solidified foam layer and applying a textile carrier layer to the adhesive layer or laminating composition. The substrate can then be removed from the outer layer. The outer layer may then optionally also be modified with a lacquer layer, for example with an acrylate- or polyurethane-based lacquer.

In yet a further embodiment, the present invention relates to the use of a flame retardant combination containing melamine cyanurate and an aluminum phosphinate in a solidified foam layer formed from a polymer dispersion or solution for reducing the thickness shrinkage of the solidified foam layer. In the present case, the term “thickness shrinkage” describes a reduction in the thickness of the laminate system occurring upon storage at elevated temperature without exerting a pressure on the laminate system. The use is preferably configured such that melamine cyanurate and aluminum phosphinate are included in the laminate system in an amount such that storage at 100° C. for 14 d (about 2% atmospheric humidity) results in a change in thickness of at most −10%, preferably at most −7% and more preferably at most −3% and/or storage at 70° C. at 95% atmospheric humidity for 14 d results in a change in thickness of at most −10%, preferably at most −7% and more preferably at most −3% (the negative prefix indicates that the thickness is decreasing). In the use, the aluminum phosphinate is preferably aluminum diethylphosphinate.

The laminate structures according to the invention may be employed in any applications in which leather is used as a surface material, for example in clothing, as a furniture covering or in architectural applications. A further aspect of the present invention accordingly relates to the use of a laminate structure as described above for producing clothing, as a furniture covering or in architectural applications. Further possible applications of the laminate structures according to the invention include packaging, insulation materials, cushioning or membranes.

As a result of the specific combination of flame retardants, the laminate structures according to the invention may be formulated in such a way that discoloration of the product after prolonged exposure to heat or UV radiation is very low, with the result that artificial leathers constructed according to the invention are readily employable for example in dashboards of vehicles. In addition, the laminate structures according to the invention retain a high level of dimensional stability even after prolonged exposure to heat (for example climatic storage at temperatures up to 105° C. over 26 weeks). A suitable outer layer and optionally an applied lacquer also allow the laminate structures according to the invention to be very resistant to abrasion and flexible, with the result that they are usable for customary seating applications in the furniture and automotive sector and pass the quality tests necessary therefor (robot test, entry and egress test). The use of suitable materials for the individual layers of the laminate structure means that said structure may be flexible over a wide temperature range (above −20° C.), thus markedly reducing the risk of breakage of the artificial leather in the seat due to brittleness at low temperatures.

Inclusion of the flame retardant combination makes it possible to realize especially the following advantages in the invention described here:
production of artificial leather/laminate materials comprising textile carriers and having a burn rate according to FMVSS 302 of less than 50 mm/min is made possible using flame retardant amounts of at most 20% in the beaten foam formulations
a usage amount of at most 20% of flame retardant (in the aqueous polymer dispersion) makes it possible to produce laminate materials having a burn rate of 0 mm/min according to FMVSS 302
halogen-free or emission-free laminate materials are producible without solvents or other hydrocarbons
the laminate structures produced are free from emissions caused by flame retardants
it is possible to produce laminate structures which in thickness exhibit only a very low thickness shrinkage after high-temperature storage at 100° C. and at 70° C./95% atmospheric humidity
the laminate structures are producible using customary transfer coatings or direct coating processes
dispersions employed especially in the beaten foam preferably include dispersions free from cosolvents and having a solids content of ≥50%.

The present invention will now be more particularly elucidated with reference to a number of illustrative examples which are not to be understood as limiting in any way in terms of the applicability or the scope of protection of the application.

### Examples

In the following, the advantages of the invention are elucidated with reference to an exemplary construction composed of a compact film based on an aqueous polyurethane dispersion in conjunction with a foamed film based on an aqueous polyurethane dispersion, a polyurethane-based laminating composition and a textile carrier.

### 1) Producing a Construction of the Laminate Structure:

### a) Producing the Compact Decorative Film:

1000 g of an aliphatic polyether polyurethane dispersion having a solids content of 60% are stirred with 15 g of a thickener based on an acrylate copolymer, 5 g of a silicone-based defoamer and 8 g of an isocyanate crosslinker (aliphatic isocyanate based on a 1,6-hexamethylene diisocyanate; 21.8% isocyanate content)

in a batch vessel for 10 min and the composition is subsequently deaerated in a vacuum atmosphere. The composition is then applied with a knife coater and a gap width of 120 μm to a suitable substrate paper and dried at 80° C. to 150° C. for 120 seconds (with an increasing temperature profile) to obtain a film having a weight of about 55-65 g/m².

### b) Producing and Applying the Foamed Film:

Production of the foamed film is elucidated by way of example with reference to the following formulation: 750 g of an aliphatic polyether polyurethane dispersion having a solids content of 60% are mixed with about 2.8 g of an acrylate-based thickener, 9.4 g of Stokal SR (foam auxiliary, Bozzetto), 9.4 g of Stokal SAF new (foam auxiliary, Bozzetto), 28 g of Stokal STA (foam auxiliary, Bozzetto) and 20 g of an isocyanate crosslinker (aliphatic isocyanate based on a 1,6-hexamethylene diisocyanate; 23.5% isocyanate content) and 200 g of a flame retardant with stirring and stirred in a batch vessel for 10 min. The composition is then foamed to a density of 500 g/l in a beaten foam mixer from Hansa and uniformly applied with a knife coater having a defined blade gap of 800 μm to the film produced in 1a) and dried at 110° C. to 155° C. for 240 seconds with an increasing temperature profile.

### c) Producing the Laminate Material by Applying the Laminating Composition and the Textile Carrier:

835 g of an aliphatic polyurethane dispersion having a solids content of 50% are mixed with about 5.9 g of an acrylate-based thickener and 16.7 g of an isocyanate crosslinker (aliphatic isocyanate based on a 1,6-hexamethylene diisocyanate; 23.5% isocyanate content) with stirring and stirred in a batch vessel for 10 min.

The composition is uniformly applied to the film produced in 1b) with a knife coater and a blade gap of 200 μm. A textile carrier (knit, polyester crepe having a weight of 120 g/m², Reichenbach) is then placed into the coated still-liquid composition and dried at 80° C. to 155° C. for 240 seconds with an increasing temperature profile. The laminate thus produced is then removed from the carrier paper and may optionally also be subjected to a surface lacquering.

Comparative examples employing customary halogen-free flame retardants having a construction according to 1a-c are listed in table 1.

Inventive examples are listed in table 2.

TABLE 1

| | | | | | Burn rate according | |
|---|---|---|---|---|---|---|
| | | | | | to FMVSS 302 in | |
| | | State | | | laminate structures | High-temperature |
| | Flame | of | | Incorporation and | for a usage amount | storage at 10° C., at |
| No. | retardant | matter | Chemical description | foaming behavior | of 20% [mm/min] | 100° C., 14 days |
| 1 | Ignisal LP57 | liquid | org. phosphorus | good | >50 mm/min | |
| | | | compound | | | |
| 2 | Ignisal P48 | solid | ammonium | strong thickening effect, | | |
| | | | polyphosphate | agglomerate formation | | |
| 3 | Melapur MC 25 | solid | melamine cyanurate | good | >50 mm/min | |
| 4 | Exolit AP 423 | solid | ammonium | strong thickening effect, | | |
| | | | polyphosphate | agglomerate formation | | |
| 5 | Exolit AP 462 | solid | ammonium | strong thickening effect, | | |
| | | | polyphosphate | agglomerate formation | | |
| | | | encapsulated in | | | |
| | | | melamine resin | | | |
| 6 | Exolit OP 1230 | solid | aluminum | good | >50 mm/min | |
| | | | diethylphosphinate | | | |
| 7 | Exolit OP 1311 | solid | org. phosphinate | good | >50 mm/min | |
| 8 | Exolit OP 550 | liquid | phosphorus-containing | good | >50 mm/min | |
| | (LV) | | polyol | | | |
| 9 | Exolit OP 560 | liquid | phosphorus-containing | good | >50 mm/min | |
| | | | polyol | | | |
| 10 | Exolit RP 6520 | liquid | red phosphorus | good | >50 mm/min | |
| | | | (dispersed) | | | |
| 11 | Reflamal 520 | solid | aluminum trihydroxide | good | >50 mm/min | |
| 12 | Melagard MP | solid | melamine phosphate | severe pH reduction, | | |
| | | | | poor foaming behavior | | |
| 13 | Phoslite B 64 | solid | aluminum phosphate, | strong thickening effect, | | |
| | | | amine | agglomerate formation | | |
| 14 | Char 52 | solid | magnesium hydroxide | agglomerate formation | | |
| 15 | Magnifin H10 | solid | magnesium hydroxide | agglomerate formation | | |
| | MV | | | | | |
| 16 | Magnifin H5 | solid | magnesium hydroxide | agglomerate formation | | |
| | MV | | | | | |
| 17 | Martinal Char- | solid | aluminum trihydroxide | good | >50 mm/min | |
| | 42 | | | | | |
| 18 | Flamtard 5 | solid | zinc stannate | drying of foam achievable | >50 mm/min | |
| | | | | only with cracks, poor | | |
| | | | | dispersibility | | |
| 19 | Nord-Min 17 | solid | expandable graphite | good | >50 mm/min | |
| 20 | Nord-Min 20 | solid | expandable graphite | good | >50 mm/min | |
| 21 | Nord-Min 35 | solid | expandable graphite | good | >50 mm/min | |
| 22 | Aflamman PPN | solid | ammonium | strong thickening effect, | | |
| | 1 | | polyphosphate | agglomerate formation | | |
| 23 | Aflammit PCI | solid | zinc borate | good | >50 mm/min | |
| | 511 | | | | | |
| 24 | Aflammit PCO | solid | org. phosphorus/nitrogen | strong thickening effect, | | |
| | 700 | | compound | not foamable | | |
| 25 | Aflammit PCO | solid | org. phosphorus/nitrogen | thickening effect, severe | | |
| | 800 | | compound | pH reduction = => | | |
| | | | | difficult to foam | | |
| 26 | Aflammit PCO | solid | cyclic phosphonate | good | <50 mm/min | migration to surface |
| | 962 | | | | | |
| 27 | Aflammit PLF | liquid | aryl phosphate esters | good | <50 mm/min | foam collapse |
| | 280 | | | | | |
| 28 | Aflammit PLF | liquid | phosphonate (cyclic) | phosphonate (cyclic) | <50 mm/min | severe yellowing on |
| | 710 | | | | | aging |
| 29 | Aflammit PMN | solid | melamine phosphate | severe pH reduction, | | |
| | 185 | | | poor foaming behavior | | |
| 30 | Aflammit PMN | solid | melamine polyphosphate | severe pH reduction, | | |
| | 200 | | | poor foaming behavior | | |
| 31 | Aflammit PMN | solid | melamine | good | <50 mm/min | migration to surface |
| | 500 | | | | | |
| 32 | Aflammit PMN | solid | melamine borate, | agglomerate formation | | |
| | 544 | | modified | | | |
| 33 | Emtex T 294 | liquid | org. nitrogen and inorg. | strong thickening effect, | | |
| | | | phosphorus compounds | not foamable | | |
| 34 | Emtex U 995 | solid | org. nitrogen compound | strong thickening effect, | | |
| | | | | not foamable | | |
| 35 | Emtex U 996 | liquid | aluminum hydroxide, org. | good | >50 mm/min | |
| | | | nitrogen compounds | | | |
| 36 | Masteret 80450 | liquid | red phosphorus | good | >50 mm/min | |
| 37 | WTH-MPP | solid | melamine polyphosphate | severe pH reduction, | | |
| | | | | poor foaming behavior | | |

TABLE 2

| | | | | Burn rate | | Change in thickness after |
|---|---|---|---|---|---|---|
| | | | Flame | according to | | 14 d at 70° C., 95% |
| | Textile | | retardant usage | FMVSS 302 | Change in thickness | atmospheric humidity |
| No. | carrier | Flame retardant | amount [g] | [mm/min] | after 14 d at 100° C. [%] | [%] |
| 38 | A | without | | 130 | | |
| 39 | A | Reflamal S 20 | 20 | 67 | −11 | −6 |
| 40 | A | Melapur MC 25/Exolit OP | 5 | 42 | −10 | −5 |
| | | 1230 (5.9:9.1) | | | | |
| 41 | A | Melapur MC 25/Exolit OP | 12.5 | 8 | −7 | −5 |
| | | 1230 (5.9:9.1) | | | | |
| 42 | A | Melapur MC 25/Exolit OP | 20 | 0 | −1 | 0 |
| | | 1230 (5.9:9.1) | | | | |
| 43 | B | Melapur MC 25/Exolit OP | 5 | 92 | −3 | −10 |
| | | 1230 (5.9:9.1) | | | | |
| 44 | B | Melapur MC 25/Exolit OP | 12.5 | 65 | −7 | −7 |
| | | 1230 (5.9:9.1) | | | | |
| 45 | B | Melapur MC 25/Exolit OP | 20 | 0 | −2 | −3 |
| | | 1230 (5.9:9.1) | | | | |

A polyester crepe, 120 g/m²;
B cotton/polyester knit (35/65), 140 g/m²

As is apparent from table 1, many flame retardant systems are unusable in beaten dispersion foams due to agglomerate formation or poor dispersibility, due to severe pH reduction or due to severe viscosity elevation or else impede mechanical homogeneous foaming (examples 2, 4, 5, 12-16, 18, 22, 24, 25, 29, 30, 32-34, 37). By contrast, other flame retardants are easily incorporable and allow homogeneous foaming of the composition but do not result in burn rates of <50 mm/min in the corresponding construction (examples 1, 3, 6-11, 17-21, 23, 35, 36). Examples 26-28 and 31 show that some flame retardants make it possible to achieve a low burn rate of <50 mm/min coupled with good incorporability and good foaming behavior. However, these flame retardants show disadvantages in a subsequent high-temperature storage such as migration of the flame retardant or constituents thereof to the surface or disadvantageous aging properties of the laminate material (e.g. clearly visible yellowing).

By contrast, a combination of flame retardants according to the invention and the use thereof in a laminate according to 1a-c achieved good incorporability and foamability of the dispersions coupled with very low burn rates (see table 2). A combination of flame retardants based on melamine cyanurate (Melapur MC 25) and based on aluminum phosphinate (Exolit OP 1230) in a usage amount of 20 g in laminates 1a-c achieved a burn rate of 0 mm/min. Even the use of only 50 g instead of 200 g of flame retardant in formulation 1b achieves burn rates below 50 mm/min in the laminate (see table 2, no. 40).

Even when another textile was used in layer 1c instead of the polyester knit (cotton/polyester knit, 140 g/m², Reichenbach), burn rates of 0 mm/min are achieved when using 200 g of flame retardant.

For the combination of the flame retardants, a ratio of melamine cyanurate to aluminum phosphinate of 5.9 to 9.1 has generally proven particularly advantageous. However, other ratios likewise result in markedly reduced burn rates relative to the comparative examples.

In addition, it has surprisingly been found that the addition of the flame retardants also brings about an improved dimensional stability after 14 days of storage at 100° C. or else after 14 days of storage in a hot and humid atmosphere, as is apparent from a markedly reduced thickness reduction compared to a reference comprising Reflamal S20 as the flame retardant (comparative example 39).

1. An aqueous polymer dispersion comprising
a dispersed polymer
a foam stabilizer and
a flame retardant mixture containing melamine cyanurate and an aluminum phosphinate.

2. The aqueous polymer dispersion as claimed in claim 1, wherein it has a flame retardant content in the range from 10 to 30% by weight, preferably 12 to 25% by weight and more preferably 15% to 20% by weight.

3. The aqueous polymer dispersion as claimed in claim 1, wherein the aluminum phosphinate is present in the form of aluminum dialkylphosphinate and preferably of aluminum diethylphosphinate.

4. The aqueous polymer dispersion as claimed in claim 1, wherein the dispersed polymer is an acrylate polymer or a polyurethane polymer, preferably a polyurethane polymer.

5. The aqueous polymer dispersion as claimed in claim 1, wherein the dispersed polymer is an aliphatic polyurethane preferably comprising polyether units.

6. The aqueous polymer dispersion as claimed in claim 1, wherein the foam stabilizer is in the form of ionic or nonionic surfactants, wherein preferably at least a portion of the foam stabilizer is formed by an anionic surfactant.

7. The aqueous polymer dispersion as claimed in claim 1, wherein the dispersion is present in the form of a foam having a gas content in the range from 10 to 65 vol % and preferably 25 to 55 vol %.

8. The aqueous polymer dispersion as claimed in claim 1, wherein the dispersion is free from halogenated flame retardants.

9. The aqueous polymer dispersion as claimed in claim 1, wherein the dispersion contains one or more crosslinkers selected from the group comprising isocyanate, carbodiimide and epoxy crosslinkers and/or one or more additives selected from fillers, in particular mineral and/or biobased fillers, thickeners, rheology additives, pH regulators, aging stabilizers and pigments.

10. The aqueous polymer dispersion as claimed in claim 1, wherein the dispersion has a pH in the range from 5 to 10 and preferably 6 to 9.

11. A laminate structure comprising two or more layers, wherein at least one of the layers is formed by solidifying the aqueous polymer dispersion according to claim 1.

12. The laminate structure as claimed in claim 11 comprising a grained outer layer, a layer of solidified foam and a textile layer on the side of the laminate system opposite the outer layer, wherein the layer of solidified foam is formed from the aqueous polymer dispersion.

13. The laminate structure as claimed in claim 11 which has a burn rate according to FMVSS 302 of less than 50 mm/min, wherein preferably the proportion of the flame retardant in the layer formed from the aqueous dispersion is less than 30% by weight.

14. A process for producing the laminate structure as claimed in claim 11, wherein the aqueous polymer dispersion in the form of a foam is applied to a substrate and solidified to afford a cohesive layer.

15. A method comprising: providing a flame retardant combination containing melamine cyanurate and an aluminum phosphinate, and using the flame retardant combination in a solidified foam layer formed from a polymer dispersion or solution for reducing the thickness shrinkage of the foam layer.

16. A method of using the laminate structure as claimed in claim 11, comprising providing the laminate structure and using the laminate structure for producing clothing, as a furniture covering or in architectural applications.
